(19) United States
(12) Patent Application Publication
(10) Pub. No.: US 2026/0166470 A1
(43) Pub. Date: Jun. 18, 2026

(54) EPOXIDATION OF POROUS AMINE-BASED PHENYLIC POLYMER RESINS AND METHODS OF USE FOR CARBON DIOXIDE CAPTURE

(71) Applicants: CLIMEWORKS AG, Zürich (CH); Svante Technologies Inc., Burnaby (CA)

(72) Inventors: Hao WANG, Burnaby, BC (CA); Davide ALBANI, Zürich (CH); Tomas AZTIRIA, Zürich (CH); Giordano AMORUSO, Zürich (CH)

(73) Assignees: CLIMEWORKS AG, Zürich (CH); Svante Technologies Inc., Burnaby, BC (CA)

(21) Appl. No.: 19/111,911

(22) PCT Filed: Sep. 13, 2023
(86) PCT No.: PCT/EP2023/075112

§ 371 Date: Mar. 14, 2025

Related U.S. Application Data
(60) Provisional application No. 63/407,013, filed on Sep. 15, 2022.

(51) Int. Cl. B01D 53/04; B01D 53/02; B01D 53/14; B01D 53/62; B01J 20/20

(52) U.S. Cl. CPC B01D 53/0462; B01D 53/02; B01D 53/1475; B01D 53/1493; B01D 53/62; B01J 20/20

(57) ABSTRACT

A solid epoxidized aminated porous phenylic polymer without the use of a porous silica support structure is described herein along with its method of synthesis and its application to the adsorption of carbon dioxide (CO₂) from a feed gas. An illustrative example of the use of 1,2-propylene oxide (epoxypropane) to epoxidize a solid porous phenylic aminated resin substrate based upon a simple one-step reaction at room temperature is described herein. This epoxidized IER exhibits approximately a three-fold improvement in lifetime upon exposure to oxygen in dry air at 110° C.-120° C. as compared to the non-epoxidized polymeric starting material.

### TECHNICAL FIELD

The present invention relates to a solid sorbent for separation of an acid gas, such as CO₂, from a gas stream with enhanced stability to oxygen at elevated temperatures, its method of synthesis and its use in systems for sorption of and acid gas such as CO₂ from a gas, including for example, the atmosphere, a flue gas and other gases containing an acid gas such as CO₂. In particular, the invention relates to the use of epoxidation to oxidatively stabilize a solid porous phenylic polymer.

### PRIOR ART

Many amine containing polymers and liquid amines have been employed in the prior art, to capture CO₂ from flue gases, other gases containing CO₂ and the ambient atmosphere. The mechanism for the reaction of CO₂ with amines is understood in the prior art as a reaction to form a cationic nitrogen (R—N+) moiety and an anionic carboxylic acid (R—COO—). Polymerized amines have been used successfully to capture CO₂ even with the ultra-low concentrations of CO₂ in the ambient atmosphere (˜0.04%). This process is known as “Direct Air Capture” (DAC).

However, the reactivity of the amine groups in these polymers with the oxygen (O₂) in the atmosphere, flue gases with typical CO₂ concentrations in the range of 3-20% by volume, and other gases containing CO₂, and O₂, at elevated temperatures, e.g. ˜100-140° C., during a desorption cycle of a Temperature Swing Adsorption (TSA) process, resulted in degradation of a capacity of aminated polymers to subsequently adsorb CO₂, i.e. they degrade in oxygen at elevated temperatures. Such degradation is accelerated at higher temperatures and/or gases with higher O₂ concentrations which come in contact with the adsorbents having these amine moieties.

Previous efforts to improve the oxygen stability of amine-containing adsorbents included adding functional groups to the polymer that are known to resist oxidation and other reactions such as phenyl groups, triazol groups and epoxide groups. Efforts to employ epoxidation to improve the oxidative stability of polyethylenimine (PEI)-based solid polymers on porous silica support structures have been successful when larger epoxides such as C₁₂-epoxide (epoxy dodecane) have been utilized to increase the hydrophobicity and increase the stability of the polymer at elevated temperatures and/or when water and/or steam condenses on the polymer.

Furthermore, even at the relatively high molecular weights of these PEI-based polymers, the resultant polymers tend to be liquid at room temperature and especially at the elevated temperatures of a TSA process. This resulted in the leaching of the polymers from the solid support structure, e.g., porous silica, when exposed to water and/or condensing steam at higher temperatures, e.g., ˜100-140° C.

Therefore, there has been a need to stabilize the viscous liquid polymers on a solid porous support structure such as porous silica. The use of epoxidation has been reasonably effective to enhance the oxygen stability of such PEI-based amines, however, the resulting adsorbent chemistry and corresponding adsorbent structures are relatively complex and are consequently relatively expensive to manufacture.

Therefore, there is a need to further enhance the oxidative stability of amine-containing polymers and in particular for porous polymers that can adsorb CO₂ without the need for a porous support structure such as porous silica. Reduced water solubility especially at elevated temperatures, since steam often condenses during a temperature swing adsorption process, is also desired.

Furthermore, it is advantageous to have a process for synthesis of the polymer which is simple and inexpensive, in order to reduce the cost of the polymer and cost for separation of an acid gas such as CO₂ from the ambient air, flue gases, or other gases.

US-A-2019168185 relates to regenerative, solid sorbents for adsorbing carbon dioxide from a gas mixture, including air, with the sorbent including a modified polyamine and a solid support. The modified polyamine is the reaction product of an amine and an epoxide. The sorbent provides structural integrity, as well as high selectivity and increased capacity for efficiently capturing carbon dioxide from gas mixtures, including air. The sorbent is regenerative, and can be used through multiple cycles of adsorption-desorption.

US-A-2016038872 relates to a method for separating CO2 and/or H2S from a mixed gas stream by contacting the gas stream with a non-aqueous, liquid absorbent medium of a primary and/or secondary aliphatic amine, preferably in a non-aqueous, polar, aprotic solvent under conditions sufficient for sorption of at least some of the CO2. The solution containing the absorbed CO2 can be treated to desorb the acid gas. The method is usually operated as a continuous cyclic sorption-desorption process, with the sorption being carried out in a sorption zone where a circulating stream of the liquid absorbent contacts the gas stream to form a CO2-rich sorbed solution, which is then cycled to a regeneration zone for desorption of the CO2 (advantageously at <100° C.). Upon CO2 release, the regenerated lean solution can be recycled to the sorption tower. CO2:(primary+secondary amine) adsorption molar ratios >0.5:1 (approaching 1:1) may be achieved.

US-A-2018008958 provides carbon dioxide adsorbents. The carbon dioxide adsorbents include a polymeric amine and a porous support on which the polymeric amine is supported. The polymeric amine consists of a polymer skeleton containing nitrogen atoms and branched chains bonded to the nitrogen atoms of the polymer skeleton. Each of the branched chains contains at least one nitrogen atom. The polymeric amine is modified by substitution of at least one of the nitrogen atoms of the polymer skeleton or the branched chains with a hydroxyl group-containing carbon chain.

US-A-2012160097 discloses an adsorption-desorption material, e.g., crosslinked epoxy-amine material having an Mw from about 500 to about 1×10⁶, a total pore volume from about 0.2 cc/g to about 2.0 cc/g, and a CO2 adsorption capacity of at least about 0.2 millimoles CO2 per gram of crosslinked material, and/or linear epoxy-amine material having an Mw from about 160 to about 1×10⁶, a total pore volume from about 0.2 cc/g to about 2.0 cc/g, and a CO2 adsorption capacity of at least about 0.2 millimoles CO2 per gram of linear material. The disclosure also involves processes for preparing the crosslinked epoxy-amine materials and linear epoxy-amine materials, as well as selective removal of CO2 and/or other acid gases from a gaseous stream using the epoxy-amine materials.

Choi et al (Nat Commun 7,12640 (2016). https://doi.org/10.1038/ncomms12640) report that amine-containing adsorbents have been extensively investigated for post-combustion carbon dioxide capture due to their ability to chemisorb low-concentration carbon dioxide from a wet flue gas. They report the versatile and scalable synthesis of a functionalized-polyethyleneimine (PEI)/silica adsorbent which simultaneously exhibits a large working capacity (2.2 mmol g−1) and long-term stability in a practical temperature swing adsorption process (regeneration under 100% carbon dioxide at 120° C.), enabling the separation of concentrated carbon dioxide. They demonstrate that the functionalization of PEI with 1,2-epoxybutane reduces the heat of adsorption and facilitates carbon dioxide desorption (>99%) during regeneration compared with unmodified PEI (76%). Moreover, the functionalization significantly improves long-term adsorbent stability over repeated temperature swing adsorption cycles due to the suppression of urea formation and oxidative amine degradation.

Min et al (Nat Commun 9, 726 (2018). https://doi.org/10.1038/s41467-018-03123-0) report that amine-containing solids have been investigated as promising adsorbents for CO2 capture, but the low oxidative stability of amines has been the biggest hurdle for their practical applications. They developed an extra-stable adsorbent by combining two strategies. First, poly(ethyleneimine) (PEI) was functionalized with 1,2-epoxybutane, which generates tethered 2-hydroxybutyl groups. Second, chelators were pre-supported onto a silica support to poison p.p.m.-level metal impurities (Fe and Cu) that catalyse amine oxidation. The combination of these strategies led to synergy, and the resultant adsorbent showed a minor loss of CO2 working capacity (8.5%) even after 30 days aging in O2-containing flue gas at 110° C. This corresponds to a ˜50 times slower deactivation rate than a conventional PEI/silica, which shows a complete loss of CO2 uptake capacity after the same treatment. The high oxidative stability may represent an important breakthrough for the commercial implementation of these adsorbents.

Goeppert et al (ChemSusChem Volume12, Issue 8, p 1712-1723, https://doi.org/10.1002/cssc.201802978) report how CO2 adsorbents based on the reaction of pentaethylenehexamine (PEHA) or tetraethylenepentamine (TEPA) with propylene oxide (PO) were easily prepared in “one pot” by impregnation on a silica support in water. The starting materials were readily available and inexpensive, facilitating the production of the adsorbents on a large scale. The prepared polyamine/epoxide adsorbents were efficient in capturing CO2 and could be regenerated under mild conditions (50-85° C.). They displayed a much-improved stability compared with their unmodified amine counterparts, especially under oxidative conditions. Leaching of the active organic amine became minimal or nonexistent after treatment with the epoxide. The adsorption as well as desorption kinetics were also greatly improved. The polyamine/epoxide adsorbents were able to capture CO2 from various sources including ambient air and indoor air with CO2 concentrations of only 400-1000 ppm. The presence of water, far from being detrimental, increased the adsorption capacity. Their use for indoor air quality purposes was explored.

WO-A-2010091831 discloses a structure containing a sorbent with amine groups that is capable of a reversible adsorption and desorption cycle for capturing CO2 from a gas mixture wherein said structure is composed of fiber filaments wherein the fiber material is carbon and/or polyacrylonitrile.

WO-A-2011049759 discloses a process for the reduction of carbon dioxide (or CO2) from various types of gas emitting sources containing carbon dioxide, including the reduction of carbon dioxide from industrial gas emitting sources via the use of an ion exchange material.

### SUMMARY OF THE INVENTION

The present invention includes the successful one-step, low-cost synthesis of oxidatively and water non-leachable stable porous aminated phenylic polymers applying an epoxidation process with small inexpensive epoxides. The cost per kg of the resulting CO₂-adsorbing polymers is in the range of ˜$10-20/kg instead of the ˜$50-$60/kg more typical of epoxy-stabilized PEI-based CO₂ sorbents.

The example of the use of epoxypropane to react with the phenylic aminated polymer (an anionic ion exchange resin) is offered as an illustrative example wherein the unreacted amine groups on the polymer greatly outnumber the epoxidized sites on the porous polymer resin. However, other epoxy compounds should also improve the oxidative stability of these phenylic polymers.

The basic chemical structure of a starting polymer before epoxidation is illustrated below in FIG. 1, where amine groups which are two carbons from a phenyl group) are interspersed among phenylic groups throughout the polymer. This illustrative example of a solid aminated porous phenylic polymer is based upon an existing polymer resin that is often utilized for Ion Exchange in aqueous solutions. The active amine groups of these Ion Exchange Resins (IER) are anionic in character and are typically activated with bases such as NaOH and are subsequently applied to ion exchange processes to capture anions in aqueous solutions such as halogen ions, e.g., chloride (Cl⁻), nitrate (NO₃⁻) and the conjugate anionic salts of carboxylic acids, (R—COO⁻). Epoxidation of the polymer structure of these IERs with small inexpensive epoxides is the subject of the present invention. FIGS. 2 and 3 illustrate the improvement in oxidative stability as measured by changes in the CO2 adsorption capacity and its stability with respect to degradation as compared to the same polymer before epoxidation.

While not being bound to any scientific explanation, it is believed that the primary amines (resin-NH₂) of the aminated phenylic polymer resin material are converted to secondary amines (resin-NH—O—R) which are also available for reaction with CO2. However, when the ratio of epoxide is higher, there is a chance that some of the secondary amines would be converted to tertiary amines which are inactive for CO2 capture.

According to a first aspect of the present invention it relates to a solid porous phenylic aminated polymer comprising epoxidized moieties (in particular in the sense of amine moieties which have been subjected to a treatment with epoxy reagents).

The solid material is typically a porous sorbent material based on an organic polymer material, preferably selected from the group of polystyrene, polyethylene, polypropylene, polyamide, polyurethane, acrylate-based polymer including PMMA, or combinations thereof, wherein preferably the polymer material is polystyrene/polyvinyl benzene based. Most preferably, the polymer material is polystyrene/polyvinyl benzene based.

The sorbent material can preferably be based on a polystyrene material throughout or preferably at least the surface exposed aromatic side chains of which are at least partially functionalized or which contain benzylamine moieties.

The term primary amines is used here to designate amines, which have one single alkyl (or aryl or alkyl-aryl) substituent bonded to the nitrogen atom, while the rest of substituents is hydrogen. The term secondary amines is used here to designate amines, which have two alkyl (or aryl) substituents bonded to the nitrogen atom, while one substituent is a hydrogen atom.

The material, preferably in porous form, and having specific BET surface area, in the range of 0.5-100 m2/g, or 1-40 m2/g, preferably 1-20 m2/g, may take the form of a monolith, the form of a layer or a plurality of layers, the form of hollow or solid fibers, including in woven or nonwoven (layer) structures, or the form of hollow or solid particles.

The sorbent material preferably takes the form of preferably essentially spherical beads with a particle size (D50) in the range of 0.002-4 mm, 0.005-2 mm or 0.01-1.5 mm, preferably in the range of 0.30-1.25 mm. Possible are also particles with a particle size (D50) in the range of 0.002-1.5 mm, 0.005-1.6 mm.

Furthermore the present invention relates to a use of such a solid porous phenylic aminated polymer, preferably in the form of cross-linked polystyrene material and most preferably poly(styrene-co-divinylbenzene), preferably functionalised by primary benzylamine, comprising epoxidized moieties, as material functionalized on the surface with amino functionalities capable of reversibly binding carbon dioxide, for separating gaseous carbon dioxide from a gas mixture, preferably from at least one of ambient atmospheric air, flue gas and biogas, preferably for direct air capture, in particular using a temperature, vacuum, or temperature/vacuum swing process, wherein said sorbent material comprises primary and/or secondary amine moieties immobilized on a solid support.

The proposed method for separating gaseous carbon dioxide from a gas mixture preferably comprises at least the following sequential and in this sequence repeating steps (a)-(e):
(a) contacting said gas mixture with the solid porous phenylic aminated polymer comprising epoxidized moieties as a sorbent material to allow at least said gaseous carbon dioxide to adsorb on the sorbent material by flow-through through a (gas separation) unit under ambient atmospheric pressure conditions and ambient atmospheric temperature conditions in an adsorption step (if ambient atmospheric air is pushed through the device using a ventilator for example, this is still considered ambient atmospheric pressure conditions in line with this application, even if the air which is pushed through the reactor by the ventilator has a pressure slightly above the surrounding ambient atmospheric pressure, and the pressure is in the range as detailed below in the definition of “ambient atmospheric pressure”);
(b) isolating said sorbent material with adsorbed carbon dioxide in said unit from said flow-through, preferably while maintaining the temperature in the sorbent;
(c) inducing an increase of the temperature of the sorbent material, preferably to a temperature between 6° and 110° C., starting the desorption of carbon dioxide (this is e.g. possible by injecting a stream of saturated or superheated steam by flow-through through the unit and thereby inducing an increase of the temperature of the sorbent material to a temperature between 6° and 110° C.);
(d) extracting at least the desorbed gaseous carbon dioxide from the unit and separating gaseous carbon dioxide from steam, preferably by condensation, in or downstream of the unit;
(e) bringing the sorbent material to ambient atmospheric temperature conditions (if the sorbent material is not cooled in this step (e) down to exactly the surrounding ambient atmospheric temperature conditions, this is still considered to be according to this step, preferably the ambient atmospheric temperature established in this step (e) is in the range of the surrounding ambient atmospheric temperature +25° C., preferably +10° C. or +5° C.).

According one aspect of the invention, the sorbent material used in such a repeating cycle comprises primary and/or secondary amine moieties immobilized on a solid support.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 bar absolute and typically ambient atmospheric temperature refers to temperatures in the range of −40 to 60° C., more typically −30 to 45° C. The gas mixture used as input for the process is preferably ambient atmospheric air, i.e. air at ambient atmospheric pressure and at ambient atmospheric temperature, which normally implies a CO2 concentration in the range of 0.03-0.06% by volume. However, also air with lower or higher CO2 concentration can be used as input for the process, e.g. with a concentration of 0.1-0.5% by volume, so generally speaking, preferably the input CO2 concentration of the input gas mixture is in the range of 0.01-0.5% by volume.

According to another preferred embodiment, the solid porous phenylic aminated polymer, preferably cross-linked polystyrene material and most preferably poly(styrene-co-divinylbenzene), preferably functionalised by primary benzylamine, comprising epoxidized moieties has a ratio of epoxidized moieties to amine groups in the polymer of less than 0.5 or has been subjected to a reaction with an epoxide under conditions where ratio of epoxy to amine groups in the polymer was less than 0.5.

Typically, this ratio is less than 0.25, less than 0.2 or in the range of 0.01-0.2, in the range of 0.02-0.15, or in the range of 0.03-0.1.

Typically, the polymer can adsorb at least 20 ml of carbon dioxide at STP per gram of polymer and the ratio of CO2 adsorbed to amine groups is 0.1 or greater as measured with at 50° C. with a 10 kPa partial pressure of CO2 in air, or the polymer can adsorb at least 40 ml of CO2 at STP per gram of polymer.

Preferably, the capacity of the polymer to adsorb CO2 does not degrade by more than 10% after 4 hours of exposure to dry air at a temperature of 110° C.

Preferably, the epoxidized moieties and/or the epoxy systems used for the modification have 10 carbons or less.

Preferably the epoxidized moieties are based on at least one of epoxypropane, epoxybutane, epoxypentane, epoxyhexane, 2-tert-butyloxirane, or the solid porous phenylic aminated polymer is reacted with at least one of epoxypropane, epoxybutane, epoxypentane, epoxyhexane, 2-tert-butyloxirane.

Normally, the polymer is a solid at a temperature of 110° C. and the polymer is stable with respect to water or condensing steam leaching at a temperature of 110° C.

Furthermore, the invention relates to a method of synthesis of a CO2 adsorbent polymer material comprising:
mixing a specific ratio of an epoxy compound, preferably having 10 carbons or less, with a solid porous phenylic polymer comprising amine groups, preferably with a preferably cross-linked polystyrene material and most preferably poly(styrene-co-divinylbenzene), preferably functionalised by primary benzylamine;
reacting the mixture at a temperature of between −30° C. and 100° C. and more preferably at a temperature of between 0° C. and 60° C. for a time to essentially complete the reaction between the epoxy and the amine group to the specified ratio; and
recovering the epoxidized polymer from the reaction,
wherein the specified ratio of epoxy moieties compared to amine groups in the resulting polymer resin is between 0.01 and 0.60 or preferably in one of the ranges given above.

The epoxy compound in that method is preferably one or a combination of epoxypropane, epoxybutane, epoxypentane, epoxyhexane, 2-tert-butyloxirane, or similar epoxy compounds.

Typically, the epoxy compound is added dropwise during mixing with the phenylic polymer and where the epoxy compound has 10 carbons or less.

Furthermore, the invention relates to a system for the capture or separation of at least one of an acid gas or CO2 from a feed gas, comprising:
the porous epoxidized aminated phenylic ion exchange polymer as detailed above; means to lower the temperature of the polymer;
means to sequentially expose the polymer to the feed gas comprising the acid gas or CO2 thereby forming a first product stream depleted in the acid gas or CO2 relative to the feed gas; and
means to desorb the adsorbed acid gas or CO2 from the polymer at an elevated temperature (relative to a temperature of the polymer, the polymer is exposed to the feed gas) thereby forming a second product stream (with an enhanced concentration of acid gas or CO2 relative to the feed gas),
whereby, the second product stream has a higher concentration of the acid gas or CO2 relative to the feed gas.

The invention also relates to a structured CO2 sorbent comprising the polymer as defined above.

The invention also relates to a naturally occurring lignin modified to form amine groups epoxidized to form an epoxidized aminated polyphenol resin.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same.

In the drawings,

FIG. 1 illustrates a basic approximate structure of a solid “BB” porous aminated phenylic polymer resin, containing active primary amine groups (—NH₂) and phenylic groups. It is the basic structure of an Ion Exchange Resin (IER) with anionic functionality for the capture of anions in solution.

FIG. 2 is a graphical representation of a comparison of the CO₂ adsorption capacity expressed as a percentage of starting capacity of both an epoxidized (using epoxy propane) version of the IER (diamonds) and that of the IER without epoxidation (circles) after exposure to dry air at an elevated temperature of 110° C. for the time indicated on the X-Axis which is representative of the temperatures encountered by the polymer during a temperature swing adsorption process. The decline in CO₂ adsorption capacity of the non-epoxidized IER control material is about 10% in about 2 cycles (hours) of exposure to dry air at 110° C., while that of the inventive epoxidized version is about 10% in about 9 hours under the same conditions.

FIG. 3 shows the change in CO2 Adsorption capacity in ml of CO2 per g of polymer of the inventive epoxidized (using epoxy propane) polymer (diamonds) compared to control material (circles) without epoxidation under oxidative stress of exposure to dry air at 110° C. for the time indicated on the x-axis. It illustrates a similar trend as FIG. 2, however, the data is presented in absolute terms of the volume in milliliters of CO2 at Standard Temperature and Pressure (STP), that is adsorbed per gram of polymer as affected by the elevated temperature. A similar improvement in lifetime of the inventive epoxidized version of the polymer as compared to the unmodified IER as was illustrated in FIG. 2 is also evident in FIG. 3.

FIG. 4 shows the CO2 Adsorption capacity in ml of CO2 per gram of polymer of the inventive epoxidized (using epoxy propane) polymer (solid lines) compared to control material (dotted lines with squares) without epoxidation under oxidative stress of exposure to dry air at ˜120° C. for the number of 1 hour cycles as on the x-axis and as a function of the ratio of epoxy moieties compared to amine groups, i.e. 0.2 to 1.0. It illustrates the data from Table 1 as the trend in CO2 adsorbent capacity (in ml of CO₂ at STP per gram of sorbent) of polymers of various epoxy propane to amine group ratios, i.e., unmodified (dotted line) 0.2, 0.4, 0.6 and 1.0 with exposure to dry air over the number of one-hour cycles as above at a temperature of ˜120-125° C. The decline in CO₂ adsorbent capacity is significant when the relative epoxy to amine ratio is increased without sufficient improvement in the oxygen stability of the resulting polymer as is evident in FIG. 4. The initial decline in CO₂ adsorbent capacity of the unmodified polymer is exponential but then it becomes almost linear after about 7 cycles (hours) of exposure to dry air at elevated temperature. The data for the 0.2 ratio of epoxy propane to amine groups initially declines in CO₂ adsorbent capacity under these conditions for the first 2 hours in an approximately exponential manner and then declines linearly after that. The other, higher ratios of epoxy propane to amine groups (0.4, 0.6 and 1.0) exhibit linear behavior in their CO2 adsorption capacity as a function of exposure time to elevated temperature dry air. However, their initial measured CO₂ adsorption capacity is reduced in direct function to the amount of epoxidation with the higher epoxy ratios exhibiting a significantly reduced CO₂ adsorption capacity.

FIG. 5 shows the change in CO2 Adsorption capacity in ml of CO2 per g of polymer of the inventive epoxidized (using epoxy propane and epoxy hexane) polymer compared to control pristine material without epoxidation under oxidative stress of exposure to dry air at 110° C. for the time indicated on the x-axis. The data is presented in absolute terms of the volume in milliliters of CO2 at Standard Temperature and Pressure (STP), that is adsorbed per gram of polymer as affected by the elevated temperature. FIG. 5a shows absolute values, while FIG. 5b shows normalized values.

FIG. 6 in FIG. 6a shows the change in CO2 Adsorption capacity in ml of CO2 per g of polymer of the inventive epoxidized (using epoxy propane) AA resin compared to control material without epoxidation under oxidative stress of exposure to dry air at 110° C. for the time indicated on the x-axis. The data is presented in absolute terms of the volume in milliliters of CO2 at Standard Temperature and Pressure (STP), that is adsorbed per gram of polymer as affected by the elevated temperature. FIG. 6a shows absolute values, while FIG. 6b shows normalized values.

FIG. 7 shows the results of Example 4, wherein in FIG. 7a the adsorption capacity loss in terms of the exposure temperature at different locations is illustrated, FIG. 7b shows the capacity loss as a function of the exposure temperature is shown and in FIG. 7c shows different resin materials compared as a function of the oxygen content.

FIG. 8 shows the change in CO2 Adsorption capacity in ml of CO2 per g of polymer of the inventive epoxidized (using different epoxy systems) polymer compared to control pristine material BB without epoxidation under oxidative stress of exposure to dry air at 110° C. for the time indicated on the x-axis. The data in FIG. 8a is presented in absolute terms of the volume in milliliters of CO2 at Standard Temperature and Pressure (STP), that is adsorbed per gram of polymer as affected by the elevated temperature. FIG. 8a shows absolute values, while FIG. 8b shows normalized values.

FIG. 9 shows the results of Example 6, wherein in FIG. 9a the performance in dry regeneration (nitrogen) is shown for the system AA, in FIG. 9b the results of the screening oxidation test for the system AA, in FIG. 9c the full degradation curve for the system AA as a function of exposure time, in FIG. 9d the performance in dry regeneration (nitrogen) for the system BB, and in FIG. 9e the results of the screening oxidation test for the system BB.

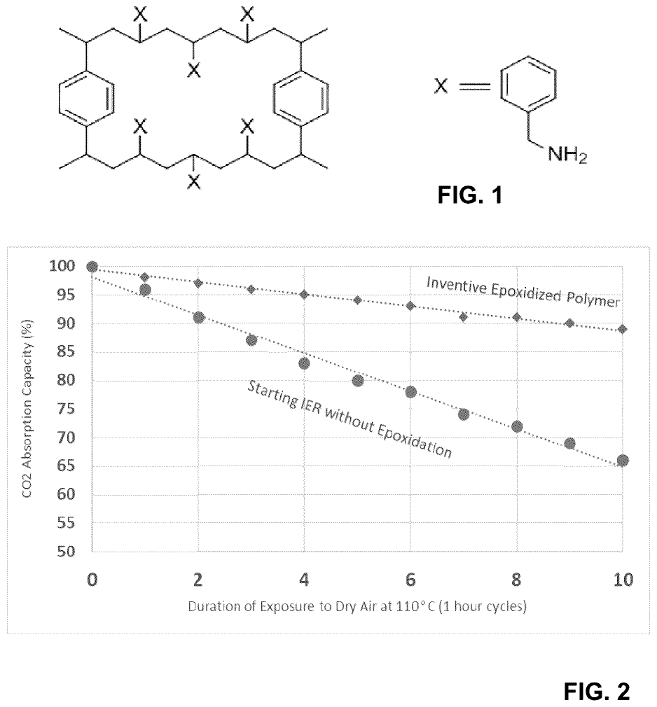

Table 1 contains the data illustrated in FIG. 4, with the CO₂ adsorption capacity in ml of CO₂ at STP per gram of polymer for the starting BB polymer and epoxidized versions of that starting material at differing ratios of epoxypropane to amine groups in the resulting modified polymer.

Table 2 contains the measured CO₂ adsorption capacity of the unmodified BB polymer and epoxidized versions of it at various epoxypropane to amine group ratios and at temperatures of 100° C., 110° C. and 120° C.

### DESCRIPTION OF PREFERRED EMBODIMENTS

### Example 1

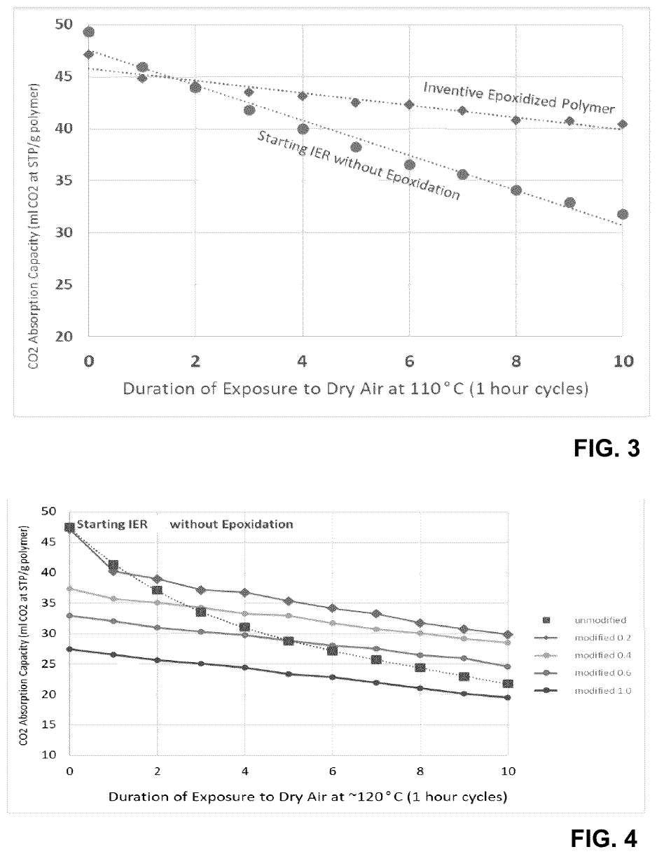

An illustrative example of the invention is contained herein. A 10% methanolic solution or rather suspension of an “BB” porous phenylic polymeric anionic ion exchange resin, with approximately 3 g of the polymer was reacted with 0.128 g (0.278 ml) of epoxypropane (1,2-epoxypropane) from Sigma-Aldrich by drop-wise addition of the epoxy to the methanolic polymer solution/suspension and then allowed to react at room temperature (˜25° C.) for ˜12-24 hours with stirring. The resulting solid was filtrated and then dried at 60° C. in a vacuum oven for 12 hours. The dried polymer was then tested for CO₂ adsorption capacity in a CO₂ testing apparatus with exposure to oxygen in dry air at 110° C. for a given number of one-hour cycles (as shown on the x-axis of FIGS. 2, 3, 4 and in Table 1).

TABLE 1
CO2 adsorption capacity in ml CO2 at STP per gram of material of
unmodified BB polymer and the same polymer epoxidized with various
ratios of epoxy to amine groups, i.e. a ratio of 0.2, 0.4, 0.6
and 1.0 epoxypropane to amine groups in the epoxidized polymer
for a number of 1 hour cycles (i.e. data presented in FIG. 4)

| | | BB2021 | BB2021 | BB2021 | BB2021 |
|---|---|---|---|---|---|
| | BB2021 | 0629M- | 0629M- | 0629M- | 0629M- |
| | 0629-0 | 0.2 | 0.4 | 0.6 | 1 |
| 0 | 47.4 | 42.7 | 37.3 | 32.9 | 27.4 |
| 1 | 41.3 | 40.2 | 35.7 | 32 | 26.5 |
| 2 | 37.1 | 38.9 | 35 | 30.9 | 25.6 |
| 3 | 33.5 | 37.1 | 34.2 | 30.3 | 25 |
| 4 | 31 | 36.7 | 33.2 | 29.7 | 24.4 |
| 5 | 28.7 | 35.3 | 32.9 | 28.8 | 23.3 |
| 6 | 27.1 | 34.1 | 31.7 | 28 | 22.8 |
| 7 | 25.7 | 33.2 | 30.7 | 27.5 | 21.9 |
| 8 | 24.4 | 31.7 | 30 | 26.4 | 21 |
| 9 | 22.9 | 30.7 | 29.1 | 25.9 | 20.1 |
| 10 | 21.7 | 29.8 | 28.5 | 24.5 | 19.4 |

The testing apparatus included a sample holder for 3 to 5 mg of the powdered solid to be suspended from a mass balance into an oven with a thermocouple to measure temperature placed within one to two cm of the sample-holder without touching the sample holder so as not to interfere with the measurement of mass by the mass balance. The temperature as measured by the thermocouple had previously been calibrated with a sample whose CO2 adsorption capacity exhibited a strong dependence on temperature. The oven also included a small flow of dry air injected into the oven volume. The approximately one-hour air exposure cycles included a temperature ramp from ambient temperature to 110° C. for a time of about 2-5 minutes. After the temperature had equilibrated at 110° C., the temperature was maintained at that temperature for one hour. After the one-hour dry air exposure, the temperature was reduced to 50° C. and the air flow was replaced by a 15% CO₂ (balance dry nitrogen) flow for ˜20 minutes during which time the CO2 adsorption capacity of the solid was measured by the change in mass of the sample (as measured by the balance from which the sample was suspended). After measurement, the air flow was resumed and another 1-hour cycle of heating to 110° C. in dry air commenced.

TABLE 2
CO2 adsorption capacity in ml CO2 at STP per gram of material
of unmodified BB polymer and the same polymer epoxidized with
various ratios of epoxy to amine groups, i.e. a ratio of 0.2,
0.4, 0.6 and 1.0 epoxypropane to amine groups in the epoxidized
polymer before and after one cycle of exposure to dry air at
5 hours at temperatures of 100° C., 110 ° C., and 120° C.

| | 5 hour | Starting CO₂ | CO₂ | |
|---|---|---|---|---|
| | Dry Air | absorption | absorption | % Change |
| | Exposure | capacity | capacity after | in CO2 |
| | Temper- | (ml CO₂ | 5 hours (ml | absorption |
| Polymer | ature | STP/g) | CO2 STP/g) | capacity |
| Unmodified BB | 110° C. | 52.1 | 43.4 | 16.7% |
| polymer | | | | |
| 0.2 epoxypropane | 100° C. | 47.4 | 45.4 | 4.2% |
| to amine ratio | | | | |
| modified | | | | |
| 0.2 epoxypropane | 110° C. | 46.6 | 43.4 | 6.9% |
| to amine ratio | | | | |
| modified | | | | |
| 0.2 epoxypropane | 120° C. | 47.0 | 41.6 | 11.5% |
| to amine ratio | | | | |
| modified | | | | |
| 0.6 epoxypropane | 110° C. | 37.9 | 35.7 | 5.8% |
| to amine ratio | | | | |
| modified | | | | |
| 1.0 epoxypropane | 110° C. | 31.8 | 29.4 | 7.6% |
| to amine ratio | | | | |
| modified | | | | |

The data presented in Table 2 illustrates the strong dependence upon temperature of the oxidative degradation rate as a function of temperature. The degradation of the unmodified BB polymer is 16.7% after 5 hours of exposure to dry air (CO₂ adsorption capacity reduced from 52.1 to 43.4 ml CO₂ at STP per gram of material). The modified polymer with a 0.2 ratio of epoxypropane to amine groups degraded by 4.2% at 100° C., 6.9% at 110° C. and 11.5% at 120° C., i.e. its oxidative degradation rate was less in percentage terms at 120° C. as compared with the unmodified BB polymer at 110° C. The original starting CO2 adsorption capacity of the materials for the 0.2 ratio of epoxypropane to amine varies somewhat, i.e. 47.4, 46.6 and 47.0 ml CO2 at STP per gram of material. This is a measure of the experimental uncertainty of the measurement with the testing apparatus, i.e. about +/−0.4 ml CO₂ at STP per gram of material.

The ˜50 ml CO₂ at STP/g adsorption capacity before oxidation degradation as measured with the method outlined above for both the unmodified IER polymer (˜9% atomic nitrogen by mass) and the 0.2 epoxy/amine ratio modified polymer can be calculated to correspond to a ratio of 0.31 molecules of CO₂ adsorbed on the polymer per amine group present in the polymer. This is similar to the values obtained from the prior art.

Subsequent testing below 0.2 epoxy/amine ratio demonstrated that the optimal ratio (best lifetime) was closer to 0.1 although 0.2 is better than higher ratios. This is presumably but not provably because some of the secondary amines previously reacted with epoxide are reacting further to form tertiary amines that are unreactive with CO2.

In order to maintain the integrity of the adsorbent material with exposure to condensing steam, the water solubility of the adsorbent should be very low. The illustrative example of the IER contained herein, has a water solubility at 100° C. of far less than 100 mg/L and is therefore highly resistant to leaching from the high temperature condensing often used for temperature swing adsorption.

It is understood that the example of the epoxidation of this ion exchange resin is illustrative of the general principle of the invention, and many variations can reasonably be deduced from this illustrative example. Another phenylic polymer (actually a polyphenol) that is naturally occurring, is the important constituent of wood, i.e., the polyphenol lignin. This material does not naturally contain amine groups. However, these natural polymers have been modified to become slow acting fertilizers by amination using a Mannich reaction.

Such a polymer would be likely to exhibit CO₂ adsorption capacity and would therefore be likely to benefit from the method disclosed herein, especially if porosity can be induced in the material or produced by coating on a porous substrate such as porous silica. Other phenylic and phenolic polymers which also contain amine groups would likewise benefit from the inventive method to become more stable with respect to oxidation at the elevated temperatures of temperature swing adsorption of CO₂.

### Example 2

The experimental procedure as described above in Example 1 was repeated, on the one hand using epoxypropane (1, 2-epoxypropane) and on the other hand using epoxyhexane (1, 2-epoxyhexane) to react with the BB resin suspension. In each case the amount of epoxy reactant was chosen such that there was a ratio of epoxy to amine groups of 0.2.

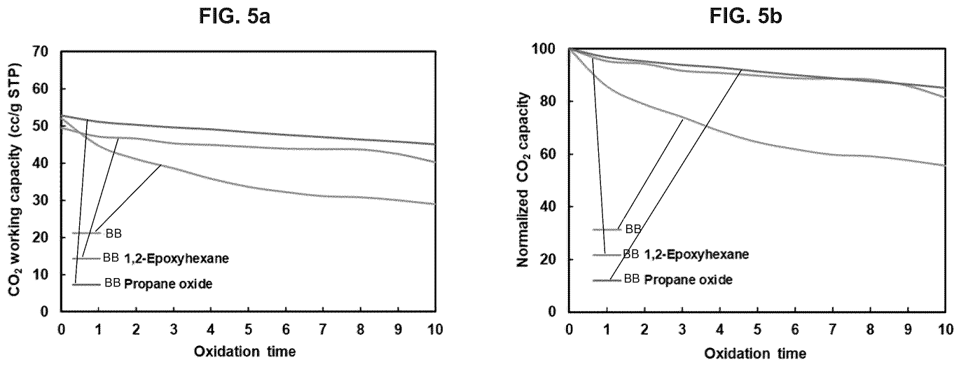

FIG. 5 shows the resulting measurements of the adsorption or capture capacity after forced O2 exposure, i.e. a Highly Accelerated Stress Test, for the BB material. The x-axis is hours of exposure to 110° C., 3% O2, 4% H2O, balance nitrogen. Also, the epoxyhexane improves the oxidation resistance. It is expected that it increases the hydrophobicity of the material which may be an advantage in certain cycles and application.

### Example 3

The experimental procedure as described above in Example 1 was repeated, using epoxypropane (1, 2-epoxypropane), but instead of using the BB material, a suspension of a different porous phenylic polymeric anionic ion exchange resin AA, was used. In each case the amount of epoxy reactant was chosen such that there was a ratio of epoxy to amine groups of 0.2.

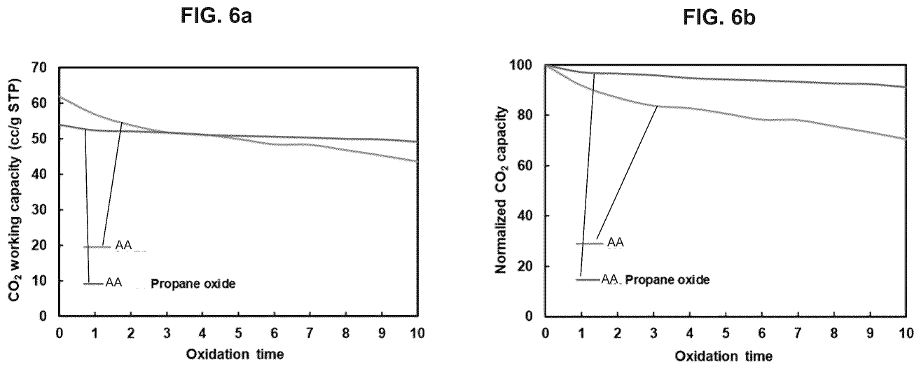

FIG. 6 shows the resulting measurements of the capture capacity after forced O2 exposure, i.e. a Highly Accelerated Stress Test, for the AA resin material. The x-axis is hours of exposure to 110° C., 3% O2, 4% H2O, balance nitrogen. Also for the other B resin material the epoxidation improves the oxidation resistance.

### Example 4

The experimental procedure as described above in Example 1 was repeated, using epoxypropane (1, 2-epoxypropane), but using the BB material and other comparable resin materials A, B (as above) and C which are based on poly(styrene-co-divinylbenzene), and which are at least partially functionalized to or contain alkylbenzylamine moieties in the form of modified moieties. In each case the amount of epoxy reactant was chosen such that there was a ratio of epoxy to amine groups of 0.2 or 20%.

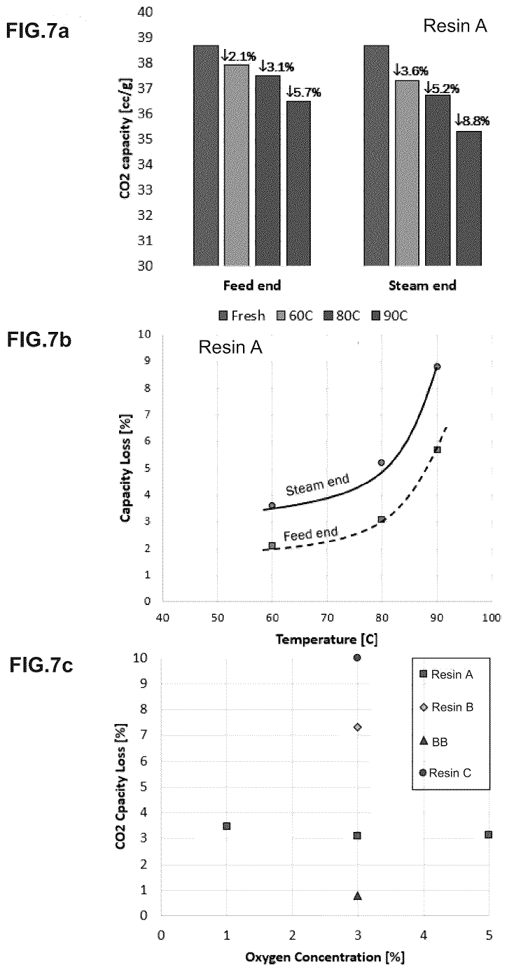

FIG. 7 shows the resulting comparisons of the Highly Accelerated Stress Test. In FIG. 7a the results of the tests on epoxidized resin A as a function of the accelerated stress test temperature are given (72 hours of exposure to varied temperatures, 3% O2, 4% H2O, balance nitrogen; TGA data at 50° C.), on the left side the feed end behavior as a function of temperature is shown, and on the right side of the steam end behavior is shown. The test was performed using the steam durability test rig (SDR). These are the conditions of the tests: Feed: 1%-10% O2, 4-5% H2O, balanced N2; Duration: 72 hours; Temperature: 80 C; Atmospheric pressure; Cycle: Feed: 3s; Steam: 1s; In FIG. 7b the capacity loss is illustrated as a function of the oxidation temperature for the same measurements of resin A (72 hours of exposure to varied temperatures, 3% O2, 4% H2O, balance nitrogen; TGA data at 50° C.). At higher temperature one observes a higher capacity loss, and in particular beyond 80° C., the carbon dioxide capacity loss is accelerated.

FIG. 7c shows a comparison of the capacity loss of the different resin materials under different oxygen concentration conditions (72 hours of exposure to 80° C., variable 02, 4% H2O, balance nitrogen). The capacity loss appears to be dependent, inter alia, on the specific polymer material used.

### Example 5

The experimental procedure as described above in Example 1 was repeated, using different epoxy reactants to react with the BB resin suspension, namely epoxypropane (1,2-epoxypropane), epoxypentane (1, 2-epoxypentane), 2-tert-butyloxirane, epoxyhexane (1,2-epoxyhexane) to compare the effects. In each case the amount of epoxy reactant was chosen such that there was a ratio of epoxy to amine groups of 0.1 or 10%

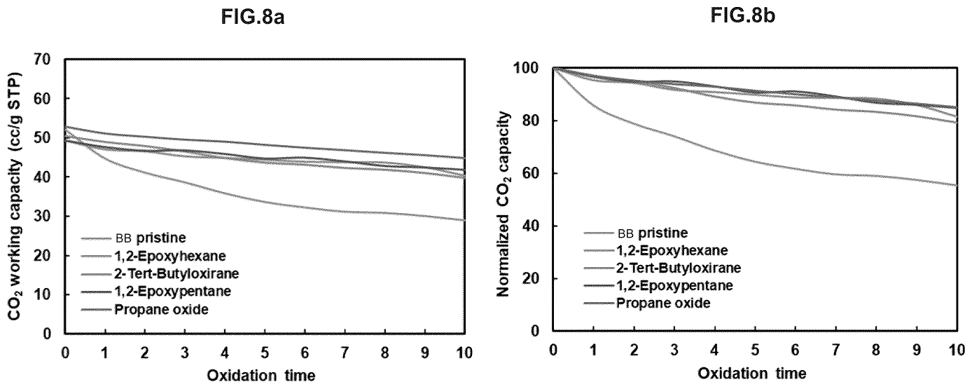

FIG. 8 shows the resulting measurements of the capture capacity after forced O2 exposure, i.e. a Highly Accelerated Stress Test, for the BB material. The X-axis is hours of exposure to 110° C., 3% O2, 4% H2O, balance nitrogen. Also the other epoxy systems improve the oxidation resistance. It is expected that the variable systems can be used to adapt water stability, hydrophobicity of the material etc. which may be an advantage in certain cycles and applications.

### Example 6

The experimental procedure similar to the one as described above in Example 1 was repeated, using epoxbutane (1,2-epoxybutane) with different molar ratios of epoxy to amine groups, to react with a suspension of a styrenic polymer crosslinked with divinylbenzene and functionalized with benzylamine units produced as described in Example 4 of WO 2022/013197 (different type AA and BB from above, differing in Total pore 0.3 vs 0.55 volume/cm3 g−1, respectively and SBET 5 vs 20 m2 g−1, respectively). Note that this example can be used for both AA and BB. An aqueous suspension made of 100 g of the porous styrenic polymer functionalised with benzylamine units and 200 mL of DI water was allowed to swell under stirring for 30 minutes. Then 0.5-5.6 g of epoxybutane (1,2-epoxybutane) from Sigma-Aldrich was added drop-wise to the polymer suspension and allowed to react at room temperature (˜25° C.) for 20 hours with stirring. The resulting solid was filtered off, rinsed with water and dried in air for 12 hours. The dried polymer was then tested for CO2 adsorption capacity in a CO2 testing apparatus with exposure to oxygen in dry air at 90° C. where samples were taken out regularly and at 90° C. for 43 h for screening. The resulting materials of the type AA were subjected to a performance test in dry regeneration (nitrogen), using the following conditions: 6 g of dry sample was filled into a cylinder with an inner diameter of 40 mm and a height of 40 mm and placed into a CO2 adsorption/desorption device, where it was exposed to a flow of 2.0 NL/min of air at 30° C. containing 450 ppmv CO₂, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO₂ adsorbed on the sorbent was determined by integration of the signal of an infrared sensor measuring the CO₂ content of the air stream leaving the cylinder.

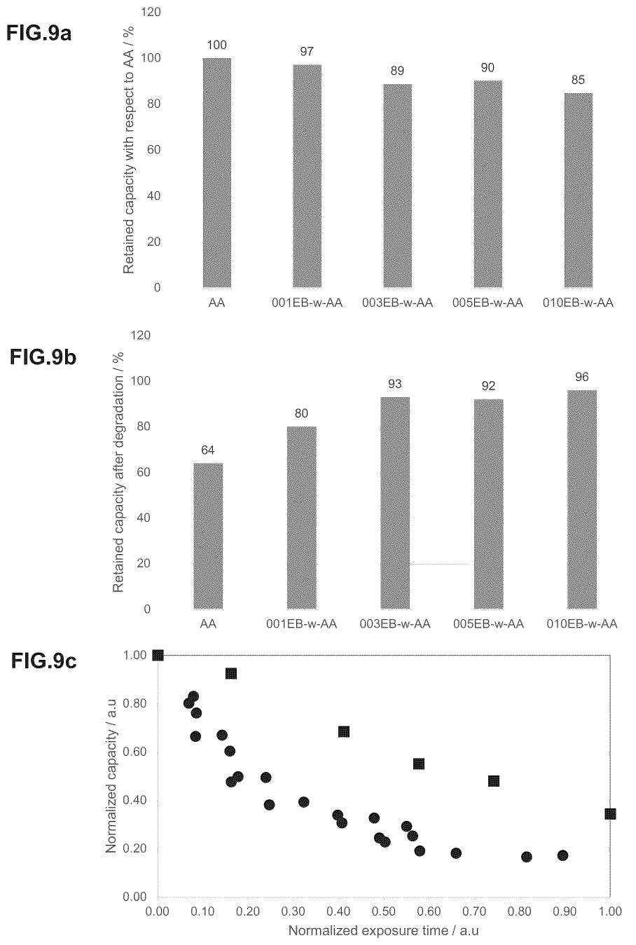

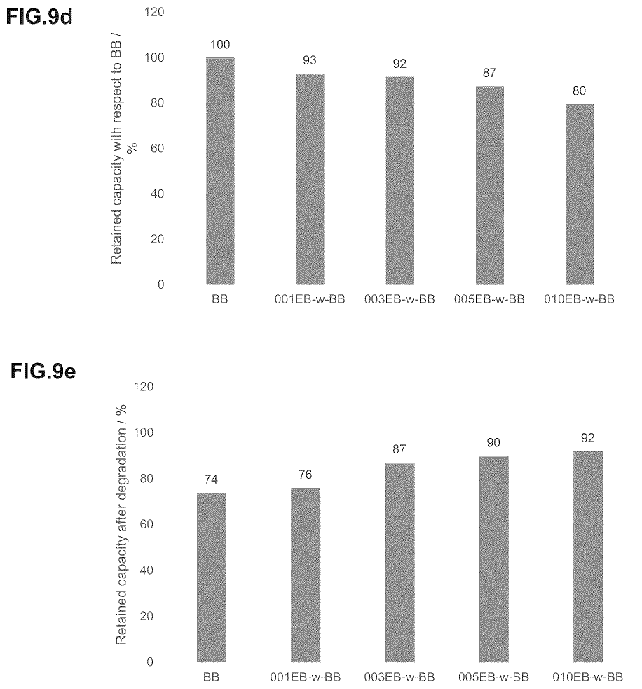

The terminology used is that for example 001 EB-w-AA stands for an epoxy to amine ratio of 0.01, use of water as solvent and resin type AA (applies to all representations in FIG. 9). The results of these measurements are given in FIG. 9a, showing that equilibrium capacity of AA almost linearly drops with increasing amount of epoxybutane.

The resulting materials of the type AA were further subjected to a screening oxidation resistance test, using the following conditions: the sorbent was placed in a petri dish and then placed in a convection oven, after 43 h of exposure at 90° C., the petri dish was taken out and the CO2 adsorption capacity of the sample was tested). As one can see from the corresponding FIG. 9b, the epoxidation leads to an increase of oxidation stability by a factor of 2-3, derived by extrapolating the curve to the time required to reach a capacity loss of 20%.

Also the full degradation curve under dry conditions was determined, using the following conditions: the sorbent was loaded in a reactor and air flow is passed through the sorbent bed, at intervals samples are taken out and then the capacity is measured with the method described above). As one can see from FIG. 9c), showing the results for pristine AA and resin of the AA type subjected to epoxybutane treatment at a ratio of 0.05, the modified material degrades significantly slower than the pristine sorbent material.

The BB starting material after treatment with increasing amount of epoxybutane was also subjected to performance tests in dry regeneration (nitrogen) as described above, the corresponding results are illustrated in FIG. 9d. The equilibrium capacity drops almost linearly by reacting more epoxide with the amino groups. The same general behavior in terms of capacity decrease as shown for the material of the type AA is displayed by sorbent BB.

Also using the BB starting material after treatment with epoxybutane, screening tests as detailed above were carried out, the resulting outcome is illustrated in FIG. 9e. Also here an increase of oxidation stability by factor 2-3 is observed.

1. A solid porous phenylic aminated polymer comprising epoxidized moieties.

2. The polymer of claim 1, wherein its water solubility at 20° C. is less than 100 milligrams per liter.

3. The polymer of claim 1, wherein the ratio of epoxidized moieties to amine groups in the polymer is less than 0.5.

4. The polymer of claim 3, wherein the ratio of epoxidized moieties to amine groups is less than 0.25.

5. The polymer of claim 1, wherein the polymer is a polystyrene material, which adsorbs carbon dioxide.

6. The polymer of claim 1, wherein the polymer can adsorb at least 20 ml of carbon dioxide at STP per gram of polymer and the ratio of carbon dioxide adsorbed to amine groups is 0.1 or greater as measured with at 50° C. with a 10 kPa partial pressure of carbon dioxide in air.

7. The polymer of claim 6, wherein the polymer can adsorb at least 40 ml of carbon dioxide at STP per gram of polymer.

8. The polymer of claim 5, wherein the capacity of the polymer to adsorb carbon dioxide does not degrade by more than 10% after 4 hours of exposure to dry air at a temperature of 110° C.

9. The polymer of claim 1, wherein the epoxidized moieties have 10 carbons or less.

10. The polymer of claim 9, wherein the epoxidized moieties are at least one of epoxypropane, epoxybutane, epoxypentane, epoxyhexane, 2-tert-butyloxirane.

11. The polymer of claim 1, wherein the polymer is a solid at a temperature of 110° C.

12. The polymer of claim 11, wherein the polymer is stable with respect to water or condensing steam leaching at a temperature of 110° C.

13. A method of synthesis of a CO₂ adsorbent material comprising:
mixing a specific ratio of an epoxy compound with a solid porous phenylic polymer comprising amine groups;
reacting the mixture at a temperature of between −30° C. and 100° C. for a period of time to react the epoxy and the amine group to a specified ratio of epoxy moieties compared to amine groups; and
recovering the epoxidized polymer from the reaction,
wherein the specified ratio of epoxy moieties compared to amine groups in the resulting polymer resin is between 0.01 and 0.60.

14. The method of claim 13, wherein the epoxy compound is one of epoxypropane, epoxybutane or epoxypentane or similar epoxy compounds.

15. The method of claim 13, wherein the resulting polymer has a capacity to adsorb carbon dioxide of equal to or greater than 20 ml of carbon dioxide at STP per gram of polymer.

16. The method of claim 13, wherein the resulting polymer has a capacity to adsorb carbon dioxide of equal to or greater than 40 ml of carbon dioxide at STP per gram of polymer.

17. The method of claim 13, where the epoxy compound is added dropwise during mixing with the phenylic polymer and where the epoxy compound has 10 carbons or less.

18. A system for the capture or separation of at least one of an acid gas or carbon dioxide from a feed gas, comprising:
the porous epoxidized, aminated phenylic ion exchange polymer of claim 1;
means to lower the temperature of the polymer;
means to sequentially expose the polymer to the feed gas thereby forming a first product stream depleted in the acid gas or carbon dioxide relative to the feed gas; and
means to desorb the adsorbed acid gas or carbon dioxide at an elevated temperature thereby forming a second product stream,
whereby, the second product stream has a higher concentration of acid gas or carbon dioxide relative to the feed gas.

19. A structured CO₂ sorbent comprising the polymer of claim 1.

20. The polymer of claim 3, wherein the ratio of epoxidized moieties to amine groups is less than 0.2 or in the range of 0.01-0.2, in the range of 0.02-0.15, or in the range of 0.03-0.1.

21. The polymer of claim 1, wherein the polymer is a cross-linked polystyrene material including poly(styrene-co-divinylbenzene), functionalised by primary benzylamine, which adsorbs carbon dioxide.

22. The polymer of claim 1, wherein the capacity of the polymer to adsorb carbon dioxide does not degrade by less than 10%, after 4 hours of exposure to dry air at a temperature of 110° C.

23. A method of synthesis of a CO₂ adsorbent material according to claim 13, comprising:
mixing a specific ratio of an epoxy compound with a solid porous phenylic polymer selected as cross-linked polystyrene material including poly(styrene-co-divinylbenzene), functionalised by primary benzylamine;
reacting the mixture at a temperature of between 0° C. and 60° C. for a period of time to react the epoxy and the amine group to a specified ratio of epoxy moieties compared to amine groups; and
recovering the epoxidized polymer from the reaction,
wherein the specified ratio of epoxy moieties compared to amine groups in the resulting polymer resin is between 0.01 and 0.60.

24. The system for the capture or separation of at least one of an acid gas or carbon dioxide from a feed gas according to claim 18, wherein the porous epoxidized is a cationic, aminated phenylic ion exchange polymer.
